(19) United States
(12) Patent Application Publication
(10) Pub. No.: US 2011/0278275 A1
(43) Pub. Date: Nov. 17, 2011

(54) ARC WELDING METHOD AND ARC WELDING APPARATUS

(75) Inventor: Daisuke MIURA, Toyohashi-shi (JP)

(73) Assignee: NEWFREY LLC, Newark, DE (US)

(21) Appl. No.: 13/164,207

(22) Filed: Jun. 20, 2011

Related U.S. Application Data
(63) Continuation of application No. PCT/US09/68786, filed on Dec. 18, 2009.

(30) Foreign Application Priority Data
Dec. 19, 2008 (JP) 2008-324269

(51) Int. Cl. B23K 9/00

(52) U.S. Cl. 219/137 R; 219/136

(57) ABSTRACT

An arc welding apparatus welds a bracket held by a welding head to a pipe by arc welding. A hollow tubular member is provided in the bracket, which tubular member is formed in a hollow conical shape or funnel, so that the diameter thereof increases from the bracket to an open mouth therein. The open mouth of the tubular member of the bracket held by the welding head is pulled up from a condition of being in contact with the pipe, an electric arc is generated between the mouth of the tubular member and the pipe to effect melting, and the open mouth is pressed against the pipe, whereupon the bracket is welded to the pipe.

### CROSS REFERENCE TO RELATED APPLICATIONS

This application is a continuation of PCT Application No. PCT/US2009//068786, filed Dec. 18, 2009 which claims the benefit of Japanese Application No. 2008-324269 filed Dec. 19, 2008, the disclosure of which is incorporated herein by reference.

### BACKGROUND OF THE INVENTION

The present invention relates to an arc welding method and arc welding apparatus for welding a weld member such as a bracket to a workpiece such as a pipe or flat plate or sheet.

Arc welding for welding a weld member such as a bracket to a workpiece such as a pipe or flat plate or sheet is well known. In Patent Literature 1, unexamined patent application No. H8-019865, a welding apparatus is according to for welding a bracket that is a weld member, for securing a wire harness to an automobile body panel that is a workpiece. The welding apparatus according to in Patent Literature 1 comprises a welding head that can hold an L-shaped bracket. In the welding apparatus according to in Patent Literature 1, because it has a welding head that can hold an L-shaped bracket, there is no need to hold the bracket that is the weld member at the weld position on the body panel that is the workpiece.

Patent Literature 1: TOKKAI [Unexamined Patent Application] No. H8-019865 (Gazette)/1996

Patent Literature 2: TOKKAI No. 2001-105142 (Gazette)

In the welding apparatus according to in Patent Literature 1 as with ordinary commonly known welding apparatuses, the welding temperature is high, so when welding a bracket to a Stefan beam that is one type of automobile crossbeam, there is a danger that warping will develop in the Stefan beam that is the workpiece due to the heat for melting both that bracket and the Stefan beam. In Patent Literature 2, unexamined patent application No. 2001-105142, a method is disclosed for welding a hollow stud having female threads formed therein to a workpiece. The end of the stud that is the welding part is formed in a shape protruding at a sharp angle in an attempt to lessen the thermal effects when welding. The welding method according to in Patent Literature 2 does reduce the thermal effects for stud welding when welding to a workpiece, but does not reduce the thermal effects when welding weld members in general, including brackets and the like, to a workpiece.

### BRIEF SUMMARY OF THE INVENTION

An object of the present invention is to reduce the thermal effects when welding weld members in general, including brackets and the like, to a workpiece, and to prevent deformation in the workpiece due to overheating.

In order to achieve the above object in an arc welding method relating to the present invention for welding a weld member to a workpiece, using an arc welding apparatus at a weld position on the weld member, a hollow tubular member protruding from that weld member is provided; that tubular member is formed in a hollow conical shape open at the mouth (funnel shaped), with the diameter thereof increasing from the weld member to its mouth and with the tubular member of the weld member held by the welding head of the arc welding apparatus positioned so that the open mouth contacts a weld location on the workpiece, the arc welding apparatus pulls the workpiece up from the workpiece, and after generating a small-current pilot arc between the mouth of the tubular member and the workpiece, then generates a large-current main arc and welds the mouth of the tubular member and the weld position portion of the workpiece; the arc welding apparatus presses the mouth of the tubular member of the weld member held by the welding head against the workpiece, attaches the mouth of the tubular member to the workpiece by fusion and welds the weld member to the workpiece.

Also, in an arc welding apparatus relating to the present invention, a hollow tubular member protruding from that weld member is provided for welding a weld member held by a welding head to a workpiece by arc welding at a weld position on the weld member; the tubular member is formed in a hollow conical shape open at the mouth, with the diameter thereof increasing from the weld member to its mouth; that arc welding apparatus operates so as, with the large-diameter open mouth of the tubular member of the weld member held by the welding head in order to contact a weld location on the workpiece, to pull the workpiece up from the workpiece and after generating a small-current pilot arc between the mouth of the tubular member and the workpiece, then to generate a large-current main arc and weld the mouth of the tubular member and the weld position portion of the workpiece, and then to press the mouth of the tubular member of the weld member held by the welding head against the workpiece, attach the mouth of the tubular member to the workpiece by fusion and weld the weld member to the workpiece.

Based on the arc welding method and arc welding apparatus according to above, a hollow tubular member protruding from a weld member is provided at a weld position on the weld member. The tubular member is formed as a hollow conical shape open at the mouth, with the diameter thereof increasing from the weld member toward the mouth. Therefore, the time of melting at a weldable temperature is shortened. Thus, the welding time can be shortened by quite a bit, and the thermal effects on the workpiece can be reduced. Consequently, deformation or warping in the workpiece due to overheating can be prevented, and proper welding can be performed without deformation, even when the workpiece is a thin-walled material. Also, because the welding time is short, better energy efficiency can be realized, and because the tubular member that is the portion welding the weld member to the workpiece is of a hollow conical shape, melting will be effected as the welding arc generated moves, turning about the interior of the cone, effects of lines of magnetic force caused by the shape of the workpiece will then not readily be sustained, and loss of strength in the weld due to welding arc bias will be prevented.

In the arc welding apparatus according to above, the angle of opening in the open mouth of the tubular member should preferably be 5 to 80 degrees relative to a straight line in the direction of the axis line of that tubular member. The diameter at the open mouth of the tubular member should preferably be 5 mm to 25 mm. And the length of the tubular member from the weld member to the aforesaid mouth should preferably be 5 mm to 50 mm. The workpiece, moreover, will typically be a pipe or a flat plate or sheet, while the weld member will typically be a bracket that can be used to attach another part.

### BRIEF DESCRIPTION OF THE SEVERAL VIEWS OF THE DRAWINGS

FIG. 1 shows the configuration of an arc welding apparatus relating to one embodiment of the present invention and welding operations thereof; 1A shows the configuration of the arc welding apparatus and the manner in which a bracket is positioned on a pipe; 1B shows the manner in which an arc is generated between a tubular member of the bracket and the pipe, with the arc welding apparatus omitted for clarity, and 1C shows the manner in which the bracket is welded to the pipe via that tubular member, with the arc welding apparatus omitted for clarity.

FIG. 2 is a diagonal view of a bracket having a tubular member.

FIG. 3 is a diagonal view of the manner in which the bracket is welded to a pipe via the tubular member.

FIG. 4 is a section of the bracket showing the tubular member of the bracket.

FIG. 5 is a diagram representing the behavior of a generated electric arc in the tubular member of the bracket.

### DETAILED DESCRIPTION OF THE PREFERRED EMBODIMENTS

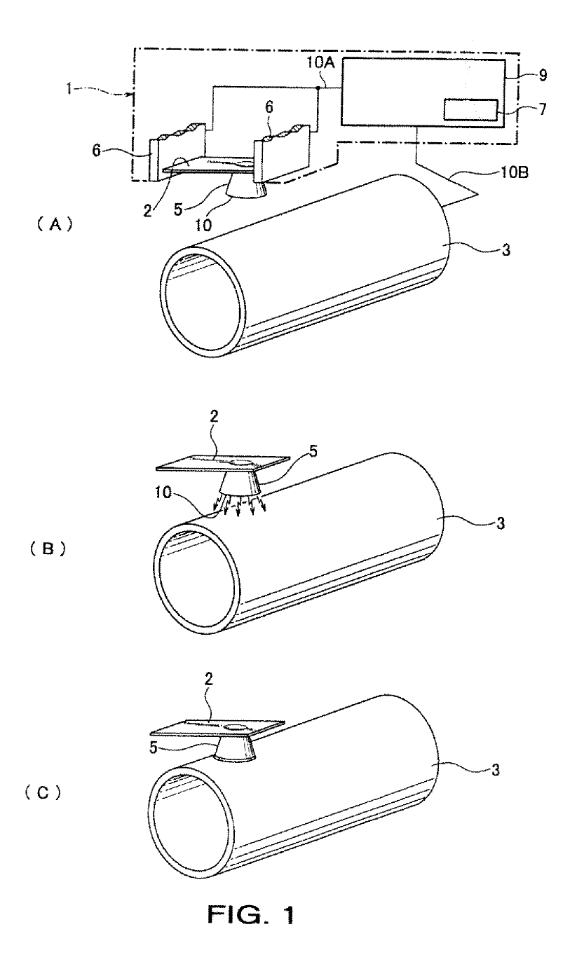

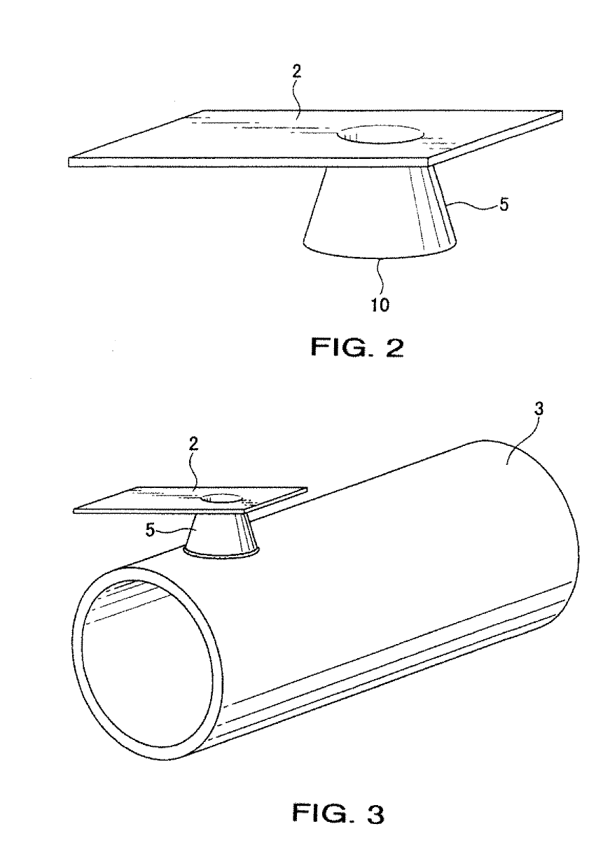

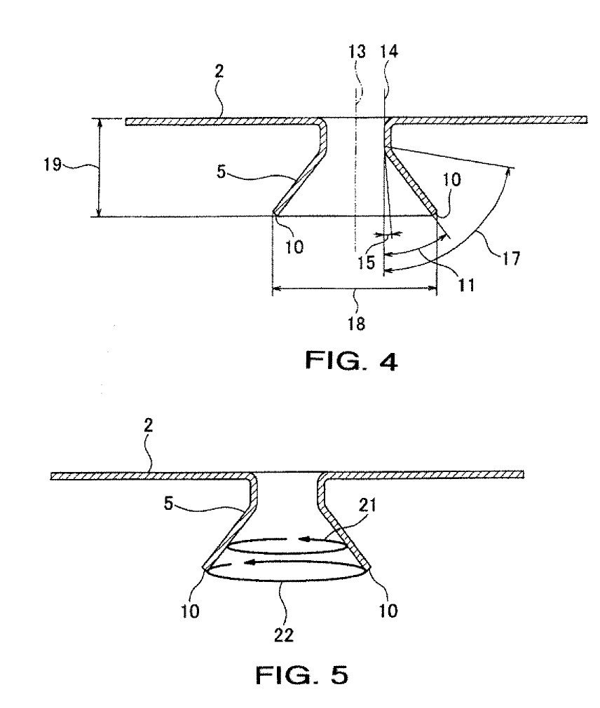

An arc welding apparatus 1 for one embodiment of the present invention shall now be according to with reference to the drawings. In FIG. 1A, the arc welding apparatus 1 is shown. In FIGS. 1B and 1C, the welding operation of the arc welding apparatus 1 is shown. FIG. 2 shows a bracket 2 that is a weld member. FIG. 3 shows a pipe 3 that is a workpiece, to which the bracket 2 has been welded. FIG. 4 is a vertical section of the bracket 2 that is the weld member, indicating preferable dimensions and angles of opening and the like for a tubular member 5 provided in the bracket 2. FIG. 5 shows the behavior of an electric arc when the tubular member 5 of the bracket 2 is being welded.

The arc welding apparatus 1 shown in FIG. 1A has a welding head 6 holding the bracket 2 that is the weld member. The arc welding apparatus 1 applies prescribed electric power to the bracket 2 held by the welding head 6 and the pipe 3 that is the workpiece, producing an arc, and welds the bracket 2 to the pipe 3. For the purpose of this welding, the arc welding apparatus 1 comprises a power supply 7 and a controller 9 for controlling the operation thereof. In order to supply the prescribed electric power for welding the bracket 2 and pipe 3, power cords 10A and 10B are connected from the controller 9 of the arc welding apparatus 1 to the bracket 2 and to the pipe 3, respectively.

In FIG. 1A, the welding head 6 of the arc welding apparatus 1 is positioned so that the circular large-diameter open mouth of the tubular member 5 of the bracket 2 (weld member) held by that welding head 6 can contact the pipe 3 (workpiece) at the weld location.

In FIG. 1B, the welding head 6 of the arc welding apparatus 1 first causes the large-diameter open mouth of the tubular member 5 of the bracket 2 held by that welding head 6 to contact the pipe 3 at the prescribed weld location. This operation of the welding head 6 is controlled by the controller 9 of the arc welding apparatus 1. Next, the controller 9 pulls the bracket 2 together with the tubular member 5 up from the pipe 3 to a prescribed height and generates a pilot arc of small electrical current between the mouth of the tubular member 5 and the weld location on the pipe 3. After generating the pilot arc, the controller generates a main arc of large electrical current and melts the mouth of the tubular member 5 and the portion of the pipe 3 that is at the weld position.

In FIG. 1C, the controller 9 detects, either by time elapsed time or by a sensor, when the mouth of the tubular member 5 of the bracket 2 held by the welding head 6 and the portion of the pipe 3 at the weld position have been properly melted, presses the melted mouth of the tubular member 5 against the portion of the pipe 3 at the weld position and attaches the mouth of the tubular member 5 to the pipe 3 by fusion. In this way, the bracket 2 that is the weld member is welded to the pipe 3 that is the workpiece.

As diagrammed in FIG. 2, in the bracket 2 that is the weld member at the weld position thereon, the hollow tubular member 5 protruding from the bracket 2 is integrally provided. The tubular member 5 is formed so that the diameter thereof increases from the bracket 2 toward its mouth and so that the mouth is an open, hollow conical shape. The bracket 2 and the tubular member 5 are formed of an electrically conductive material. Preferably, both the bracket 2 and the tubular member 5 are formed integrally of the same electrically conductive material. They can be formed, for example, by subjecting an electrically conductive metal to sheet metal machining.

As diagrammed in FIG. 3, the bracket 2 that is the weld member is welded to the pipe 3 that is the workpiece using the tubular member 5, via the operations shown in FIGS. 1A to 1C, by the arc welding apparatus 1.

The particulars of the tubular member 5 shall now be according to with reference to FIG. 4. The tubular member 5, as according to in the foregoing, is formed integrally with a bracket 2 as a hollow tubular member protruding from the bracket at a weld position on the bracket 2 that is the weld member. The tubular member 5 is formed as a hollow conical or funnel shape, and its diameter increases from the plane of the bracket 2 to an open mouth 10. The conical shape of the tubular member 5 need not necessarily be a proper conical shape but may be formed, as shown, such that the portion near the bracket 2 is formed in a cylindrical shape 4 and the portion of intermediate height and beyond is formed as a funnel cone or, alternatively, that shape may be a trapezoidal conical shape having a conical shape in the portion thereof on the mouth end inclusive of the open mouth 10. The mouth 10 of the tubular member 5, moreover, is open. In tests, the tubular member 5 was formed by subjecting a prescribed portion of the bracket 2 to a burring process and molding the protruded portion resulting from that burring process into a conical shape.

Various tests were conducted on specific dimensions and angles for the tubular member 5. From the results of these tests, the following data were obtained. For the angle of opening 11 in the open mouth 10 of the tubular member 5 relative to a straight line 14 extending in the same direction as the axis line 13 of the tubular member 5 and parallel thereto (that is, the straight line 14 extending along the conical portion at the root of the tubular member 5), the minimum angle 15 is 5 degrees, and the maximum angle 17 is 80 degrees. Within this range of angles of opening 11, favorable welding results were obtained. Moreover, when the diameter 18 at the open mouth 10 of the tubular member 5 was 5 mm to 25 mm, favorable welding results were obtained. Furthermore, the range of the length 19 of the tubular member 5 from the plane of the bracket 2 that is the weld member to the open mouth 10 was made 5 mm to 50 mm, and when that was the case, favorable welding results were obtained.

In FIG. 5, the behavior of the electric arc generated when welding the tubular member 5 of the bracket 2 to the pipe 3 is shown. The arc was observed to be continuously generated while moving in a circumferential direction about the interior of the cone in the open mouth 10 of the tubular member 5, as indicated by the arrows 21 and 22. In this way, even when welding time (that is, the main arc generation time) for the open mouth 10 of the tubular member 5 is short, an adequate molten condition is realized in the open mouth 10 portion thereof. Accordingly, if the generation of the main arc is stopped and the open mouth 10 of the tubular member 5 is pressed against the pipe 3 at the prescribed location, the open mouth 10 will properly be attached to the pipe 3 by fusion, and the bracket 2 will be welded to the pipe 3. Accordingly, the welding time can be made extremely short, thermal effects on the pipe that is the workpiece can be reduced, deformation or warping in the pipe or other workpiece due to overheating can be prevented, and proper welding can be performed without deformation, even when the workpiece is a thin-walled material. Because the welding time is short, better energy efficiency can be realized, and because the electric arc moves so as to revolve about the interior of the cone, effects of lines of magnetic force caused by the shape of the workpiece will not readily be sustained, and loss of strength in the weld due to welding arc bias will be prevented.

As according to in the foregoing, in order to weld a weld member to a workpiece, a conically shaped tubular member provided in a weld member is rendered the workpiece. In this way, welding time is shortened, thermal effects on the workpiece can be lessened, welding to a thin sheet with little energy becomes possible, the area of the weld increases, and stable welds of high strength can be effected. The workpiece, moreover, may typically be a flat plate or sheet instead of the pipe noted in the foregoing. Also noted in the foregoing, a bracket that can be used for attaching another part is typically used as the weld member, but it can also be some other member.

It will be appreciated by persons skilled in the art that the above embodiments have been according to by way of example only, and not in any limitative sense, and that various alterations and modifications are possible without departure from the scope of the invention as defined by the appended claims.

What is claimed is:

1. An arc welding method for welding a weld member to a workpiece using an arc welding apparatus including a welding head, wherein the method comprises the steps of:
providing a hollow tubular member protruding from the weld member at a weld position on the weld member; that tubular member including a hollow conical shape open at the mouth, with the diameter thereof increasing from the weld member to the mouth;
holding the hollow tubular member of the weld member by the welding head of the arc welding apparatus;
positioning the weld member so that the open mouth contacts a weld location on the workpiece;
pulling the weld member up from the workpiece with the arc welding apparatus;
generating a small-current pilot arc between the mouth of the tubular member and the workpiece,
generating a large-current main arc;
melting the mouth of the tubular member and the weld position portion of the workpiece;
pressing against the workpiece the mouth of the tubular member of the weld member held by the welding head, and
welding the mouth of the tubular member to the weld position portion of the workpiece.

2. An arc welding apparatus for welding a weld member held by a welding head to a workpiece by arc welding; wherein the arc welding apparatus comprises:
a weld member including a flat planar portion;
a tubular member protruding perpendicularly from that weld member at a weld position on the weld member; the tubular member is formed as a hollow conical shape open at the mouth, with a diameter increasing from the weld member to the mouth; and
an arc welder including a welding head operable to hold the weld member with the large-diameter open mouth of the tubular member in contact at a weld location to be welded on the workpiece.

3. The arc welding apparatus according to claim 2, wherein the angle of opening in the open mouth of the tubular member is in the range of 5 to 80 degrees relative to a straight line in the direction of the axis line of that tubular member.

4. The arc welding apparatus according to claim 2, wherein the diameter at the open mouth of the tubular member is in the range of 5 mm to 25 mm.

5. The arc welding apparatus according to claim 2, wherein the length of the tubular member from the weld member to the mouth is in the range of 5 mm to 50 mm.

6. The arc welding apparatus according to claim 2, wherein the workpiece is a pipe or a flat plate or sheet.

7. The arc welding apparatus according to claim 2, wherein the weld member is a bracket that can be used for attaching another part.

9. A weld bracket for arc welding to a workpiece; wherein the weld bracket comprises:
a weld member including a flat planar portion;
a tubular member protruding perpendicularly from that weld member at a weld position on the flat planar portion; the tubular member including a hollow conical shape open at a mouth, with a diameter increasing from the weld member to the mouth; and

10. The weld bracket according to claim 9, wherein the tubular member further including a cylindrical portion located between the flat planar potion of the weld member and the hollow conical shape.

11. The weld bracket according to claim 9, wherein the tubular member defines an axis and the open mouth and the axis define an angle of opening in the range of 5 to 80 degrees.

12. The weld bracket according to claim 9, wherein the open mouth of the tubular member defines a diameter in the range of 5 mm to 25 mm.

13. The weld bracket according to claim 9, wherein the flat planar portion of the weld member and the mouth define a length in the range of 5 mm to 50 mm.

14. The weld bracket according to claim 9, wherein the workpiece is a pipe or a flat plate or sheet.

15. The weld bracket according to claim 9, wherein the weld bracket can be used for attaching another part.
